(19) United States
(12) Patent Application Publication
(10) Pub. No.: US 2011/0076587 A1
(43) Pub. Date: Mar. 31, 2011

(54) HIGHLY ELECTRICALLY CONDUCTIVE SURFACES FOR ELECTROCHEMICAL APPLICATIONS AND METHODS TO PRODUCE SAME

(75) Inventors: CONGHUA WANG, West Windsor, NJ (US); LIN ZHANG, Edison, NJ (US); GERALD A. GONTARZ, JR., Spotswood, NJ (US)

(73) Assignee: TREADSTONE TECHNOLOGIES, INC., Princeton, NJ (US)

(21) Appl. No.: 12/892,791

(22) Filed: Sep. 28, 2010

Related U.S. Application Data
(60) Provisional application No. 61/246,523, filed on Sep. 28, 2009.

(51) Int. Cl. H01M 8/24; B22F 7/00; C23C 4/10; B05D 3/10; B32B 5/16; H01M 8/10

(52) U.S. Cl. 429/465; 428/552; 427/453; 427/448; 216/13; 428/328

(57) ABSTRACT

A method to use a novel structured metal-ceramic composite powder to improve the surface electrical conductivity of corrosion resistant metal substrates by thermal spraying the structured powder onto a surface of a metallic substrate is disclosed. The structured powder has a metal core and is wholly or partially surrounded by an electrically conductive ceramic material such as a metal nitride material. The metal cores may have the ceramic material formed on them prior to a thermal spraying process performed in an inert atmosphere, or the thermal spraying may be performed in a reactive atmosphere such that the ceramic coating forms on the cores during the thermal spraying process and/or after deposition. The metal cores will bond conductive ceramic material onto the surface of the substrate through the thermal spray process.

This application claims priority from U.S. Provisional Application Ser. No. 61/246,523 filed Sep. 28, 2009. The entirety of that provisional application is incorporated herein by reference.

### BACKGROUND

1. Field

The present invention relates to enhancement of surface electrical conductivity for electrochemical applications. More specifically, the present invention relates to the use of a thermal spray process to deposit a small amount of electrically conductive ceramic material on a corrosion resistive surface, such as a metal substrate, to maintain low surface electrical contact resistance.

2. Discussion of the Background

Metal components are widely used in various electrochemical devices, including but not limited to the electrode in chlor-alkali processes and separator plates in fuel cells. Metal components are also used in batteries, electrolyzers and electrochemical gas separation devices. In most of these applications, the metal components need to have high electrical conductance (or low electrical resistance) of the metal surface to reduce the internal electrical losses of the electrochemical devices for high operational efficiency. The major challenge for these applications is that the metal component must be corrosion resistive while maintaining its high electrical conductance.

U.S. Pat. No. 6,379,476 discloses a special stainless steel that has a large number of electrical conductive metallic inclusions of carbide and/or boride. These conductive inclusions grow inside the alloy body through a heat treatment process, and protrude through an outer surface of passive film from the stainless steel under the passive film to reduce the electrical contact resistance of the stainless steel.

US Patent application US 2005/0089742 discloses a process to protrude the conductive metallic inclusions through the surface layer and a passive film of the metal surface.

U.S. Pat. No. 7,144,628 discloses a method of using thermal spray process to deposit a corrosion resistant metallic coating on the metal substrate surface.

Typical thermal spray process has been used in various industries for surface engineering. The powders used in the process include pure metal, pure ceramic, blended metal and ceramic powders in which each individual particle is either metal or ceramic, and alloyed powders in which each individual particle has both metal and ceramic components. The alloyed powders typically have a uniform distribution of metal and ceramic in the body of each particle. The metal works as the binder to hold ceramic powder together, and bind the ceramic powder with the substrate after it is thermal sprayed on the substrate.

Reactive thermal spray processes involve spray metal powder in a reactive gas atmosphere. As discussed by Lugscheider in Advanced Engineering Materials 2000, 2, No. 5, P281-284, the metal powder could react with nitrogen or methane in the spray process to form nitride and carbide particles. These particles are enclosed in the metal coating to improve the coating wear resistance.

European Patent application EP 1 808 920 A1 (2006) discloses a method to use transition metal carbide or nitride, and/or a solid solution based on the nitrides or carbides as the catalyst for fuel cell. It could reduce the fuel cell cost, and improve the catalyst impurity tolerance.

### SUMMARY

An objective of this invention is to disclose a method to improve the surface electrical conductance of corrosion resistive metallic components. Among the possible applications of this invention is electrochemical devices, including fuel cells, batteries, electrolyzers, and gas separation devices.

An advantage of the disclosed method is that it can produce the metal components for electrochemical power devices that have high electrical conductance and corrosion resistance at a low cost.

### BRIEF DESCRIPTION OF THE DRAWINGS

FIG. 1A is the schematic drawing of a structure of a powder that has a metal core and a conductive ceramic outer layer that completely covers the metal core.

FIG. 1B is the schematic drawing of the structure of a powder that has a metal core and a conductive ceramic outer layer that partially covers the metal core.

FIG. 1C is the schematic drawing of the structure of a powder that has a metal core and a conductive ceramic outer layer and conductive ceramic particles trapped in the metal core.

FIG. 2 is the schematic drawing of a thermal spray system used in some embodiments.

FIG. 3 is the schematic drawing of a metal substrate with Ti or Cr metal/alloy splats that are covered by a nitride or oxide-nitride alloy surface layer.

FIG. 4 is a schematic diagram of a fuel cell employing a metal component according to one embodiment as a separator plate.

### DETAILED DESCRIPTION

In the following detailed description, a plurality of specific details, such as types of materials and dimensions, are set forth in order to provide a thorough understanding of the preferred embodiments discussed below. The details discussed in connection with the preferred embodiments should not be understood to limit the present inventions. Furthermore, for ease of understanding, certain method steps are delineated as separate steps; however, these steps should not be construed as necessarily distinct nor order dependent in their performance.

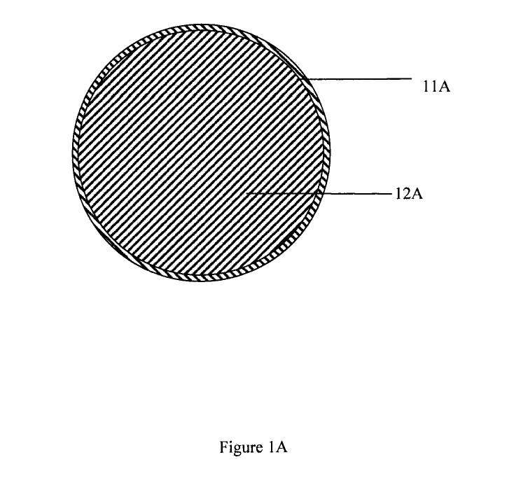

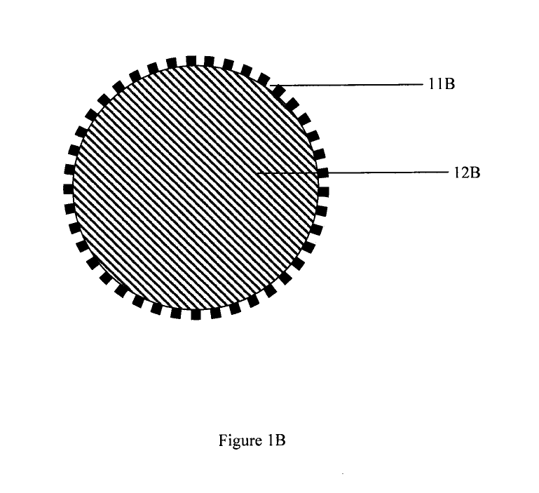

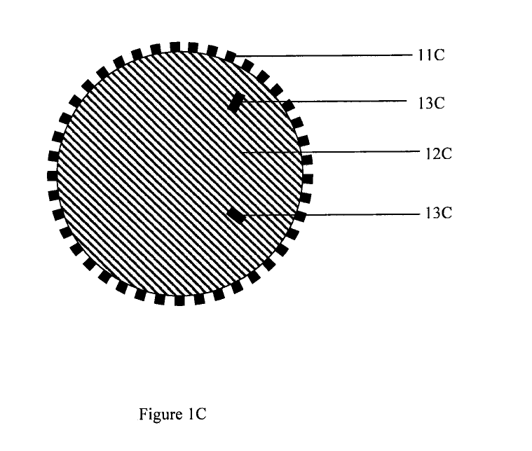

A method to use a novel structured metal-ceramic composite powder to improve the surface electrical conductivity of corrosion resistant metal substrates is disclosed herein. FIG. 1A shows a schematic drawing of the powder according to a first embodiment. The powder has a metal core 11A, and an electrically conductive ceramic surface layer 12A that completely covers the metal core 11A surface. The conventional process to produce the powder is to sinter the metal powder in the controlled atmosphere, such as in nitrogen or methane at high temperature. The metal will react with the atmosphere gases to form the conductive ceramic layer on the metal core surface. The metal core could be corrosion resistant metal, such as nickel, cobalt, aluminum, chromium, titanium, niobium, tungsten, tantalum or their alloys. The electrically conductive ceramic layer could be carbide, nitride, boride, oxides of any of the foregoing, and/or alloys of these materials such as titanium oxide nitride TiOₓN_{y}.

FIG. 1B shows a schematic drawing of the powder that has a different structure. It has a metal core 11B, and an electrically conductive ceramic surface layer 12B that partially covers the metal core 11B. The metal core could be corrosion resistant metal, such as nickel. cobalt, aluminum, chromium, titanium, niobium, tungsten, tantalum or their alloys. The electrically conductive ceramic layer could be carbide, nitride, boride, oxides of any of the foregoing, and/or alloys of any of these materials.

FIG. 1C shows a schematic drawing of a powder that has yet another different structure. It has a metal core 11C, an electrically conductive ceramic surface layer 12C that completely or partially covers the metal core 11C surface, and some small amount of electrically conductive chips 13C trapped in the metal core 11C. The electrically conductive chips 13C are naturally trapped into the metal core during the process to form the electrically conductive ceramic surface layer 12C. (For example, a plasma reactive sintering process, which is actually plasma spray into empty space (not a substrate) in a controlled atmosphere, may be used. In the plasma sintering process, the metal core will reach up to 2500° C. and be melted, and react with the atmosphere gases to form the conductive ceramic layer on the surface. During this process, the conductive ceramic layer may crack and the conductive ceramic formed on the surface of the metal droplet may be trapped in the metal core.) The metal core could be a corrosion resistant metal, such as nickel, cobalt, aluminum, chromium, titanium, niobium, tungsten, tantalum or their alloys. The electrically conductive ceramic layer and the chips could be carbide, nitride, boride, oxides of any of the foregoing, and/or alloys of any of these materials.

The conventional process to produce the novel structured powder is through a high temperature (700° C.-1300° C.) reaction of the metal powder in the reactive atmospheres, such as nitrogen atmosphere for nitride coating, hydrocarbon atmosphere for carbide coating. The metal powder will react with the gases in the atmosphere to form the conductive ceramic layer on the surface.

The novel structured powder that has the electrically conductive ceramic on the surface (FIG. 1 A-C) could be formed before spray through a thermal chemical reaction, or formed in situ during the thermal spray process through the reaction of metal droplets with the atmospheric gases of the thermal spray flame or plasma plume. In the latter case, the formation of the conductive ceramic layer and the powder deposition is conducted in a single step. The ceramic layer formation reaction can occur as the metal droplets are in flight, or after they are deposited on the surface, or both (i.e., some of the ceramic coating forms during a chemical reaction with the atmosphere as the metal droplets are in flight, and additional ceramic material is formed after the metal droplets have been deposited on the surface).

A preferred method to use the novel structured powder as described in FIG. 1 A-C is to deposit the powder by a thermal spray process onto a metal substrate to improve the surface electrical conductivity of substrate material. The sprayed splats could be formed as a continuous layer, or as isolated islands that cover a portion of the substrate surface.

The metal substrate could be a corrosion resistive metal, such as titanium, niobium, zirconium, tantalum and their alloys, or low cost carbon steel, stainless steel, copper, aluminum and their alloys with a corrosion resistive surface treatment.

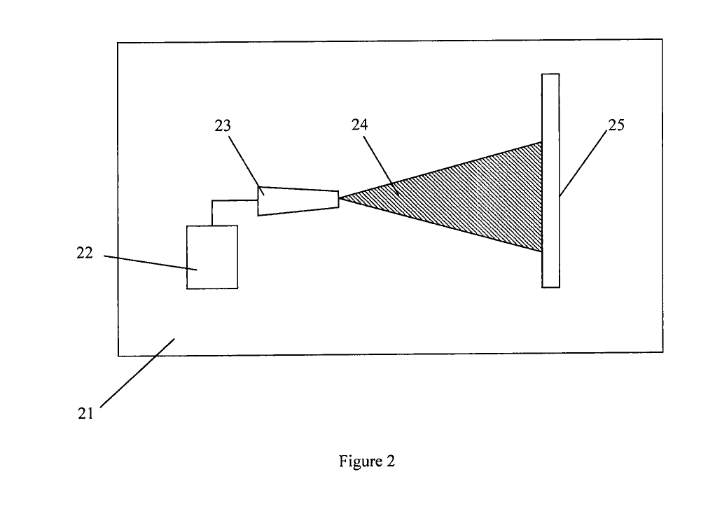

A thermal spray system that may be used in this invention is schematically shown in FIG. 2. The process is conducted under controlled atmosphere conditions to maintain the inert (e.g., argon or hydrogen) or reactive (e.g., nitrogen or methane) atmosphere 21. The powder feeder 22 should be operated with the inert or reactive gases. The spray nozzle 23 is used to spray powders to form melted metal droplets 24, and spray it out to a metal substrate 25. The spray nozzle 23 could be a plasma spray nozzle, or can be other kinds of spray nozzles known in the art.

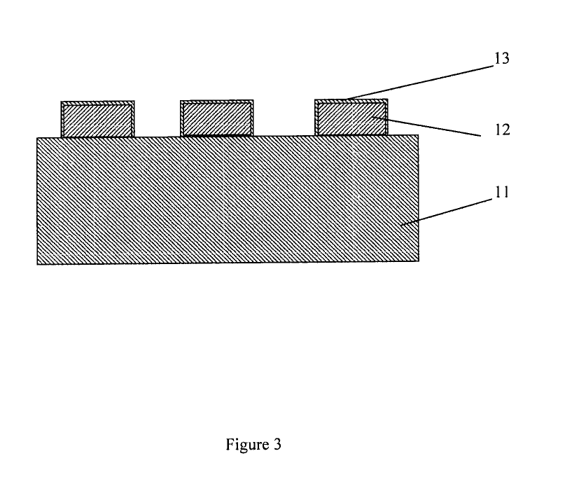

In one embodiment of the invention, some titanium or chromium metal or alloy particles are deposited by a thermal spray process, and bonded on the metal substrate surface. The thermal spray process is conducted in a nitrogen containing atmosphere. The titanium or chromium metal particles are sprayed out through the thermal spray nozzle, and melted in the flame. The titanium or chromium melt droplets will react with the nitrogen in the atmosphere, producing a layer of nitride, or oxide-nitride on the droplet surface. The droplets will then splash on the surface of the substrate, and bond on the substrate as the splats. The surface of the splats could further react with the nitrogen containing atmosphere, resulting in the nitride covering surface of the splats with some nitride of oxide-nitride chips trapped in the splats or on the splat-substrate interface. A schematic drawing of this embodiment is shown in FIG. 3. FIG. 3 illustrates a metal substrate 31 partially covered by titanium or chromium splats 32 and a thin nitride or oxide-nitride cover 33 on the splats 32. Nitride or oxide-nitride chips 34 are enclosed in some or all of the splats 32. The thickness of the splats 32 is about 0.1 μm to 100 μm, and preferably between about 1-5 μm. The thickness of the nitride, or oxide-nitride layer 33 is about 1 nm-5 μm, preferably between about 5 nm-1 μm.

Because titanium nitride and chromium nitride (or oxide-nitride) are corrosion resistant and electrically conductive, the nitride or oxide-nitride cover of the titanium or chromium splats will works as the electrical contact points of the metal substrates with other components in the electrochemical systems. The splats could cover the metal substrate surface in the form of isolated islands, or be connected together. In order to minimize the material usage, is it not necessary to cover the whole surface of the metal substrate.

Table 1 shows the electrical contact resistance of a porous carbon paper (SGL 24BA) with a 304 stainless steel foil that has sprayed titanium-titanium oxide-nitride splats on the surface. The titanium-titanium oxide-nitride splats are formed by plasma spray titanium powder in a controlled nitrogen containing atmosphere. As shown in Table 1, the initial contact resistance of the sprayed 304SS is 14 mΩ·cm² under 150 psi compression pressure. After 24 hours of corrosion under 0.8V_{NHE} cathodic polarization in pH3 H₂SO₄+0.1 ppm HF solution, the electrical contact resistance maintains almost the same low value. On the other hand, the bare 304SS will have significant surface oxidization in the corrosive environment, which results in significant high electrical contact resistance increase (100-200 mΩ·cm²) after the corrosion.

TABLE 1
Comparison of Electrical Contact Resistance of 304SS Foil Over
Porous Carbon Paper

Contact Resistance (mΩ · cm²)

| Sample # | Before Corrosion | After Corrosion |
|---|---|---|
| Ti—TiN/304SS | 14 | 15 |
| 304 SS | 30 | 200 |

In another embodiment, some titanium or chromium metal (or alloys or the foregoing) particles with the nitride layer on the powder surface are deposited by a thermal spray process, and bonded on the metal substrate surface. The nitride on the powder surface is processed through a high temperature gas nitriding process before the thermal spray deposition process. With the pre-nitrided powder, the thermal spray process is conducted in an inert (argon or hydrogen) atmosphere or in a nitrogen containing atmosphere to prevent the extensive oxidization of the nitride during the thermal spray process. The titanium or chromium core of the particles are sprayed out through the thermal spray nozzle and melted in the flame. The particles will splash on the surface of the substrate, and bond on the substrate as splats that have the nitride exposed on the surface. In order to further improve the surface electrical conductivity, an additional chemical, or electrochemical etching process could be used to remove the metal on the nitride surface, and further expose the nitride on the splat surface.

In yet another embodiment, tungsten metal powder particles with tungsten carbide layers on the powder particle surfaces are deposited on a corrosion resistant metal substrate surface. The particles will splash on the metal substrate and bond on its surface. In order to further increase the surface area of the splats, and improve the chemical stability, the splats on the metal substrate surface could go through a chemical, or electrochemical etching process to dissolve the less stable phases, and increase the surface roughness for a high surface area. The tungsten carbides on the surface will be used as the electrode catalyst for bromine-hydrogen or bromine-zinc flow batteries, or the water electrolyzer for hydrogen generation, and the metal substrates will be used as the separator plates of the battery stacks.

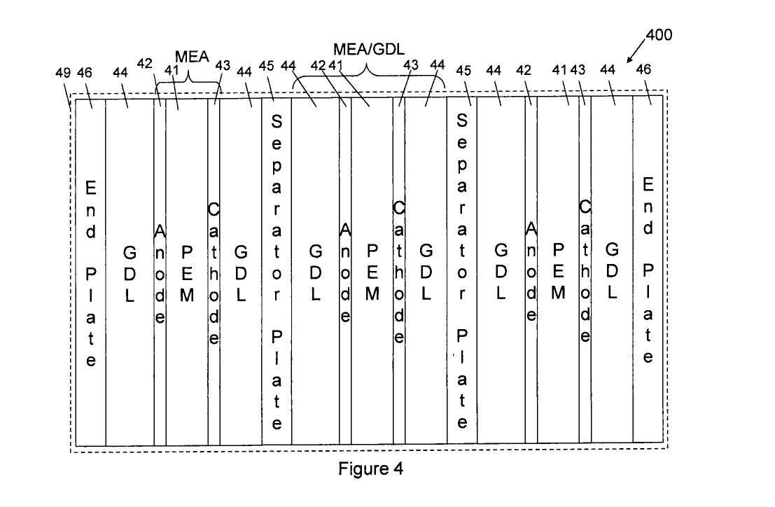

As discussed above, metal components of the type disclosed herein are useful in a wide variety of electromechanical devices. For example, metal components formed using the techniques disclosed herein may be used as separator plates in fuel cell stacks used in fuel cells. An exemplary fuel cell 400 is illustrated in FIG. 4. The fuel cell 400 comprises a fuel cell stack 40 disposed in a container 49. The fuel cell stack 40 includes three membrane electrode assembly/gas diffusion layers (MEA/GDLs), each comprising a proton exchange membrane 41 with an anode 42 and a cathode 43 on opposite sides of the PEM 11 to form MEAs, and gas diffusion layers 44 adjacent the MEAs on opposite sides. Separator plates 45, which may be formed using the techniques disclosed herein, are disposed between adjacent MEA/GDLs, and end plates 46 are present on opposite ends of the fuel stack 40 formed by the three MEA/GDLs. The separator plates 45 illustrated in FIG. 4 are referred to as bi-polar separator plates as they have an anode 42 on one side and a cathode 43 on the other side. Fuel cell stacks with mono-polar separator plates formed by the techniques disclosed herein in which the anode and cathode are swapped in adjoining MEAs are also within the scope of the present invention. Either of these types of fuel cell stacks may be combined with additional components (manifolds, etc., not shown in FIG. 4) to form fuel cell devices as is well known in the art. Metal components of the type disclosed herein may be used to form separator plates of the type disclosed in co-pending U.S. patent application Ser. No. 12/777,126, entitled “High Power Fuel Stacks Using Metal Separator Plates” filed on May 10, 2010, the entire contents of which are hereby incorporated by reference herein.

Another use for metal components of the type disclosed herein is in electrolyzers. For example, metal components of the type disclosed herein may be used as an electrode in electrolyzers of the types disclosed in U.S. Pat. No. 4,643,818 and U.S. Pat. No. 7,763,152. Yet other uses for metal components of the type disclosed herein is as separator plates in battery stacks and as the electrode catalyst for hydrogen-air fuel cells as discussed above; in chlor-alkali electrolytic cells such as those disclosed in U.S. Pat. No. 5,290,410; and in electrochemical gas separation devices. The devices illustrated in the aforementioned patents should be understood to illustrative of a wide variety of devices with which metal components of the present invention may be used, and the details of these patents should not be understood as in any way limiting of such uses. The contents of all of the patents listed above in this paragraph are hereby incorporated by reference herein.

The foregoing examples are provided merely for the purpose of explanation and are in no way to be construed as limiting. While reference to various embodiments is made, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

Additionally, the purpose of the Abstract is to enable the patent office and the public generally, and especially the scientists, engineers and practitioners in the art who are not familiar with patent or legal terms or phraseology, to determine quickly from a cursory inspection the nature of the technical disclosure of the application. The Abstract is not intended to be limiting as to the scope of the present inventions in any way.

What is claimed is:

1. A method for producing a metal component with a highly electrically conductive surface comprising:
depositing a structured powder onto a metallic substrate using a thermal spray process in a controlled atmosphere;
wherein the powder comprises a plurality of particles, each particle having a metal core at least partially surrounded by an electrically conductive ceramic coating, and wherein the particles are bonded to a surface of the metallic substrate.

2. The method of claim 1, wherein the electrically conductive ceramic coating completely surrounds the metal core of the particles.

3. The method of claim 1, wherein the electrically conductive ceramic coating partially surrounds the metal core of the particles.

4. The method of claim 1, wherein the metal core has a ceramic particle trapped therein.

5. The method of claim 1, wherein the metal core is formed from a corrosion resistive material selected from the group consisting of tungsten, nickel, cobalt, aluminum, chromium, titanium, nobium, tantalum and alloys of any of the foregoing.

6. The method of claim 1, wherein the electrically conductive ceramic coating is formed of a material selected from the group consisting of carbide, nitride, boride, oxides of any of the foregoing, and alloys of any of these materials.

7. The method of claim 1, wherein the controlled atmosphere is a reactive atmosphere and wherein the electrically conductive ceramic coating forms on the metal core during the thermal spray process through reaction of the metal core with the reactive atmosphere.

8. The method of claim 7, wherein the reactive atmosphere contains nitrogen, and wherein the metal core comprises titanium, chromium, tungsten, niobium, tantalum or an alloy of them.

9. The method of claim 1, wherein the controlled atmosphere is an inert atmosphere and wherein the electrically conductive ceramic coating is formed on the metal cores prior to the thermal spray process.

10. The method of claim 9, wherein the electrically conductive ceramic coating is formed on the metal cores using a plasma sintering process performed prior to the depositing step.

11. The method of claim 1, wherein the particles completely cover the surface of the metallic substrate.

12. The method of claim 1, wherein the particles form a plurality of islands that cover a portion of the surface of the metallic substrate.

13. The method of claim 1, further comprising:
etching the surface after the depositing step to remove exposed metal such that additional ceramic material on the surface is exposed.

14. The method of claim 1, wherein a maximum thickness of the metal cores of the powder particles bonded to the surface of the metallic substrate is approximately 0.1 micron to 100 microns.

15. The method of claim 14, wherein a thickness of the ceramic coating covering the metal cores of the powder particles bonded to the surface of the metallic substrate is approximately 1 nanometer to 5 microns.

16. A metal component formed by the method of claim 1.

17. A fuel cell stack comprising:
a first fuel cell, the first fuel cell comprising
a membrane electrode assembly comprising a proton exchange membrane, a first electrode on one side of the proton exchange membrane and a second electrode on an opposite side of the proton exchange membrane;
a first gas diffusion layer on a first side of the membrane electrode assembly;
a second gas diffusion layer on a second side of the membrane electrode assembly;
a second fuel cell; and
a separator plate between the first fuel cell and the second fuel cell, the separator plate being a metal component formed according to the method of claim 1.
